(19) United States
(12) Patent Application Publication
(10) Pub. No.: US 2025/0225960 A1
(43) Pub. Date: Jul. 10, 2025

(54) STRINGED INSTRUMENT

(71) Applicant: Tetsuya NISHI, Kanagawa (JP)

(72) Inventor: Tetsuya NISHI, Kanagawa (JP)

(21) Appl. No.: 18/853,620

(22) PCT Filed: Mar. 30, 2023
(86) PCT No.: PCT/JP2023/013133

§ 371 Date: Oct. 2, 2024

(30) Foreign Application Priority Data
Apr. 5, 2022 (JP) 2022-063078

(51) Int. Cl. G10D 3/06; G10D 1/08; G10G 1/02

(52) U.S. Cl. CPC G10D 3/06; G10D 1/08; G10G 1/02

(57) ABSTRACT

To provide a guitar that enables various information items for assisting musical performance to be displayed on a fingerboard constituted by a liquid-crystal display and an electroluminescent display, and that enables musical performance without damage to the display. What is disclosed is a guitar having a fingerboard 5 that is provided on the surface of a neck body 4 and that comprises a liquid-crystal display or an electroluminescent display; and a plurality of frets f that are arranged atop the finger-board 5 at predetermined intervals from each other. The frets f each have a support section fa at both ends in a length direction, and the frets f span the fingerboard 5 as a result of the support sections fa being fixed to the neck body 4.

### PRIORITY CLAIM

This is a U.S. national stage of application No. PCT/JP2023/013133, filed on Mar. 30, 2023. Priority is claimed on Japanese Application No. 2022-063078, filed Apr. 5, 2022, the content of which is incorporated herein by reference.

### BACKGROUND OF THE INVENTION

### Technical Field

The present invention relates to a stringed instrument assisting musical performance of a player.

### Background Art

Conventionally, a practice guitar is considered which is equipped with a fingerboard having the function of displaying a position where a string is pressed, and/or the like.

In this type of guitars, for example, a light-emitting diode (hereinafter referred as an “LED”) is placed in a neck so that the LED illuminates to indicate a position of a string to be operated. In such guitars, a plurality of LEDs is arranged in a matrix in an area corresponding to between frets on a fingerboard.

### CITATION LIST

### Patent Literature

PTL 1: Japanese unexamined patent application publication No. H11-249651

PTL 2: Japanese unexamined patent application publication No. 2005-266728

PTL 3: Japanese unexamined patent application publication No. H9-6331

### SUMMARY OF INVENTION

### Technical Problem

As described above, for the guitars using LEDs, any LED placed between frets should not be arranged to interfere with the player plucking a string. For this purpose, each LED is embedded in a neck body on the underside of the fingerboard such that the light emission is visible through the surface of the fingerboard but strings are not obstructed.

However, placing a plurality of LEDs on the underside of the fingerboard in alignment requires much time and effort, thus making the guitar more expensive. Furthermore, unless the LEDs are arranged with precision, a problem arises of the impossibility of displaying correctly a position where a string is pressed.

On the other hand, the use of a liquid crystal display or an electroluminescent display as a fingerboard, instead of the LEDs, may be conceivable. If a fingerboard is essentially made up of a liquid crystal display or an electroluminescent display, various pieces of information can be displayed such as detailed information may be displayed on the fingerboard, and/or the like. Furthermore, because it is sufficient to attach the display in the form of a single sheet to the surface of the neck body, the alignment is decisively easier than a plurality of LEDs is arranged.

However, for mounting frets on the fingerboard essentially made up of a liquid crystal display or an electroluminescent display, the frets are required to be arranged on the display surface. Because of this, there is a possibility that a press force acts on the display through the frets pressed with the string tension so as to cause damage to the display.

It is an object of the present invention to provide a stringed instrument that enables various pieces of information for assisting musical performance to be displayed on a fingerboard which is essentially made up of a liquid crystal display or an electroluminescent display, and that enables musical performance without damage to the display.

### Solution to Problem

A first aspect of the present invention provides a stringed instrument including: a fingerboard that is mounted on a surface of a neck body and is essentially made up of either a liquid crystal display or an electroluminescent display; and a plurality of frets that are spaced at predetermined intervals from each other on the fingerboard. The frets include support portions at both longitudinal ends. The frets are configured to span the fingerboard by securing the support portions to the neck body.

In a second aspect of the present invention, the frets are out of contact with the fingerboard.

In a third aspect of the present invention, the stringed instrument includes linear coupler portions that are secured to the neck body to couple together the support portions of adjacent frets of the plurality of frets arranged on the fingerboard, and all the plurality of frets is combined together.

In a fourth aspect of the present invention, the stringed instrument includes a transparent cover member that covers an area between the adjacent frets on the fingerboard, and maintains a dimensional relationship that prevents a surface of the cover member from extending above surfaces of the frets.

In a fifth aspect of the present invention, the stringed instrument includes: a receiving portion that receives, from an external terminal, control data synchronized with output of the external terminal; and a processing portion that controls display on the fingerboard based on the control data received at the receiving portion.

In a sixth aspect of the present invention, the control data output from the external terminal is data for displaying a press position mark on the fingerboard and in an area corresponding to a position where a string is to be pressed.

In a seventh aspect of the present invention, the control data output from the external terminal is data for displaying a tablature symbol predetermined according to a string operating method on the fingerboard and in proximity to the press position mark displayed.

In an eighth aspect of the present invention, the control data output from the external terminal is data for displaying a chord name to be played next on the fingerboard and in proximity to the press position mark displayed.

### Advantageous Effects of Invention

According to the first aspect of the present invention, because the frets span the fingerboard made up of a display and are secured to the neck body by the support portions installed at both ends thereof, the press force to act on the frets by the string tension escapes to the support portions, so that the press force is prevented from acting on the surface of the fingerboard essentially made up of a liquid crystal display or an electroluminescent display. Therefore, the guitar is able to be played without the press force acting on the display, i.e., the fingerboard, through the frets while displaying information for assisting musical performance such as a string press position, a playing method and/or the like.

According to the second aspect of the present invention, the press force acting on the frets is not more easily transferred to the surface of the fingerboard. This enables reliable prevention of damage to the display constituting the fingerboard.

According to the third aspect of the present invention, because all the frets may be handled as a unit, mounting to the neck body and replacement can be facilitated. Further, the surface heights of all the frets may be uniformly managed and thus the height positions of all the frets may be optimally maintained with ease.

According to the fourth aspect of the present invention, the depth of the depression between a fret and a fret is able to be adjusted by the cover member. If the depth from the surface of the fret to the bottom of the depression is too large, a string may tend to be hardly pressed, which causes a strain to be put on the player's fingers. However, if the depth of the depression between frets is adjusted by mounting the cover member that does not extend above the surface of the fret, by pressing a string against the surface of the cover member, the overpress of the string may be prevented.

According to the fifth aspect of the present invention, various marks/symbols are able to be displayed on the fingerboard based on the control data output from the external terminal.

According to the sixth aspect of the present invention, the press position mark displayed on the fingerboard may indicate a position where a string is to be pressed to assist the musical performance.

According to the seventh aspect of the present invention, the tablature symbol, together with the press position mark, may be displayed on the fingerboard to instruct a playing method.

According to the eighth aspect of the present invention, a subsequent code name, together with the press position mark, may be displayed to achieve smoother chord performance.

### BRIEF DESCRIPTION OF DRAWINGS

FIG. 1 is an overview diagram of a guitar according to a first embodiment.

FIG. 2 is a perspective view of frets according to the first embodiment.

FIG. 3 is a sectional view taken along line III-III of FIG. 1.

FIG. 4 is a block diagram of a controller according to the first embodiment.

FIG. 5 is display examples of a string press position mark and a tablature symbol on a fingerboard according to the first embodiment.

FIG. 6 is examples of tablature symbols to be displayed on the fingerboard according to the first embodiment.

FIG. 7 is display examples on the fingerboard during chord performance according to the first embodiment.

FIG. 8 is a sectional view of a neck according to a second embodiment.

### DESCRIPTION OF EMBODIMENTS

### First Embodiment

A first embodiment according to the present invention will now be described.

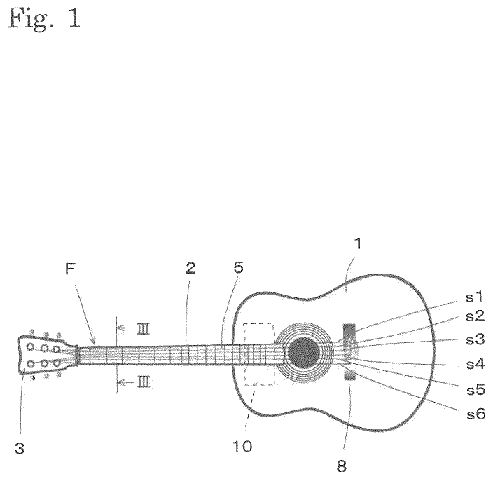

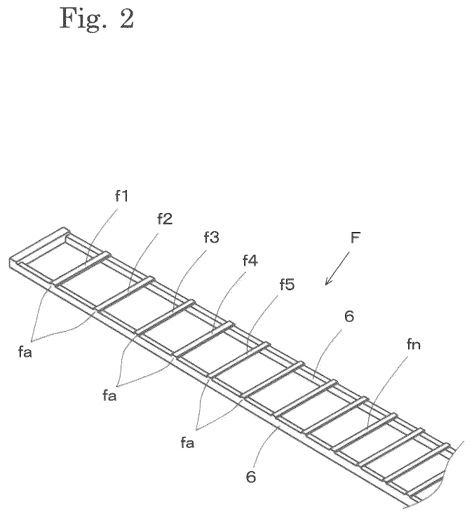

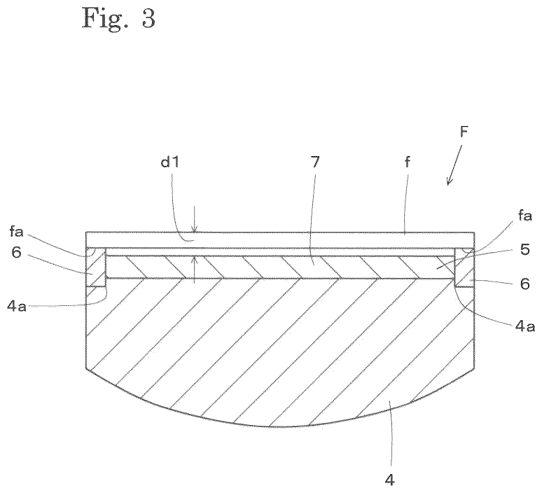

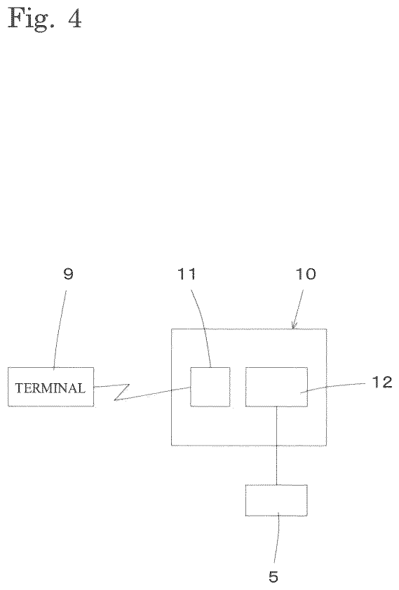

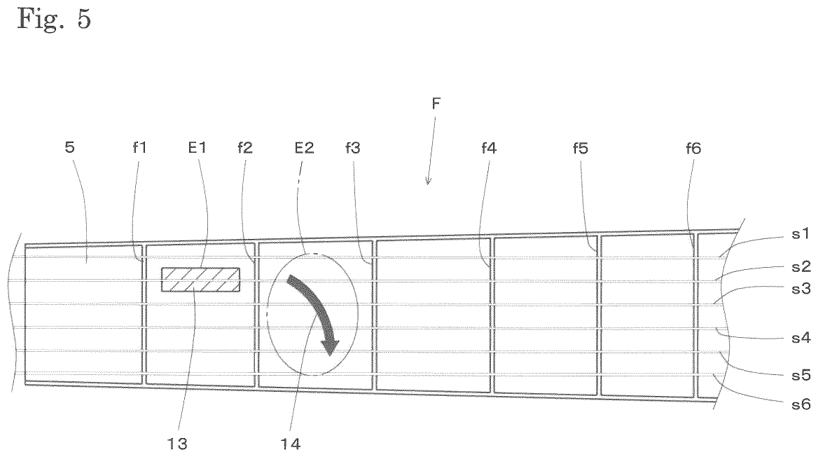

FIG. 1 is an overview diagram of a guitar according to an embodiment. FIG. 2 is a perspective view of frets. FIG. 3 is a sectional view taken along line III-III of FIG. 1. FIG. 4 is a block diagram of a controller according to the first embodiment. Further, FIG. 5 to FIG. 7 illustrate display examples of marks and symbols on the fingerboard.

As illustrated in FIG. 1, a guitar in the first embodiment includes a body 1, a neck 2 and a head 3. As illustrated in a sectional view of FIG. 3, the neck 2 includes a fingerboard 5 and a fret member F, the fingerboard 5 being made up by attaching a single sheet of liquid crystal display (hereinafter referred to as a “LED”) on the surface of a neck body 4, the fret member F being mounted to the neck body 4 so as to span the fingerboard 5.

As illustrated in FIG. 2, the fret member F is a ladder-shaped member with a plurality of frets f spaced at predetermined intervals from each other on the fingerboard 5 along the neck body 4 and each having both ends coupled respectively to two elongated coupling members 6 which are linear coupler portions.

The frets f are expressed as a first fret f1, a second fret f2, . . . , n^{th} fret fn from closer to the head 3, but any fret is indicated as a fret f unless positional distinction specifically requires. At each longitudinal end of the fret f, a portion coupled to the coupling member 6 is a support portion fa of the fret f.

For such a fret member F, the coupling members 6 are placed respectively along both sides of the surface of the neck body 4. As illustrated in FIG. 3, the coupling member 6 is partially mounted to be fitted into a recess 4a formed along each side of the surface of the neck body 4, and the frets f span the fingerboard 5. In the first embodiment, a slight clearance 7 is maintained between the frets f and the fingerboard 5 so that the frets f and the fingerboard 5 are kept in a non-contact condition. Each fret f may be formed into a c shape or a bow shape, so that the support portions fa which are both longitudinal ends may be secured directly to the neck body 4 without use of the coupling members 6.

As described above, after the fret member F is mounted to the neck 2, as illustrated in FIG. 5, a first string s1 to a sixth string s6 are stretched over the frets f from a bridge 8 of the body 1 to the head 3.

Further, within the body 1, a control box 10 is installed for controlling display on the fingerboard 5 essentially made up of the LCD.

As illustrated in FIG. 4, the control box 10 includes a receiving portion 11 that receives control data synchronized with output from an external terminal 9, and a processing portion 12 that controls display of the LCD, which is the fingerboard 5, based on the control data received at the receiving portion 11.

The external terminal 9 includes a wireless communication function and a control data creation function of creating and outputting control data for displaying marks/symbols based on a piece of music to be played on a guitar according to the embodiment, which is such as, e.g., a personal computer, a smartphone, and the like. Upon selection of a piece of music on a display screen and/or the like, the external terminal 9 starts outputting the control data corresponding to the piece of music. Here, for example, the external terminal 9 causes the control data creation function to create control data based on data on guitar musical score. For example, the control data creation function is implemented by an application program in a personal computer or the like.

The control data of the fingerboard 5 is data for assisting musical performance for each piece of music, which is data for displaying a string press mark 13 and/or a tablature symbol 14 on the fingerboard 5, the string press mark 13 indicating a to-be-pressed position on a string to be operated, the tablature symbol 14 indicating a string operating method (see FIG. 5).

The string press mark 13 is a mark indicating a position where a string is to be pressed, which is displayed in an area E1 of the fingerboard 5 corresponding to the to-be-pressed string and the frets.

Specifically, a rectangular string press mark 13 is displayed in a rectangular area E1 along the second string s2 between the first fret f1 and the second fret f2 on the fingerboard 5.

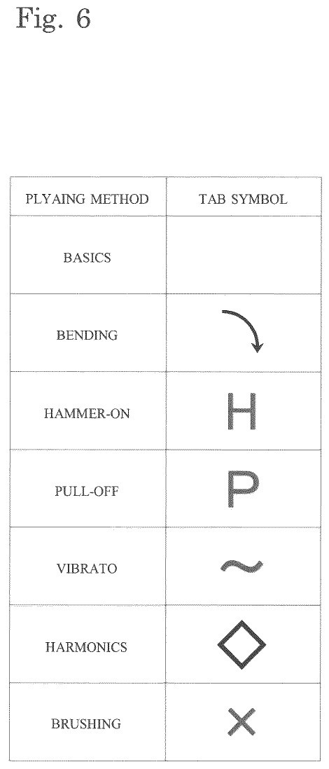

Also, the processing portion 12 has a function of displaying the tablature symbol 14 based on the control data received at the receiving portion 11. The tablature symbol 14 is a symbol according to the playing method, which is configured to be displayed in an area E2 between the second fret f2 and the third fret f3, i.e., in the area E2 in proximity to the string press mark 13. FIG. 6 shows examples of the tablature symbols according to the playing method, which are displayed in orientation as shown diagrammatically when the player looks at his/her hands from above.

### Operation, Advantageous Effects, Etc.

When the player plays a certain piece of music on the above-described guitar, upon selection of the certain piece of music through the external terminal 9, required control data is output. Then, based on the control data received at the receiving portion 11, the processing portion 12 of the control box 10 causes the fingerboard 5 to display the string press mark 13 and/or the tablature symbol 14 thereon.

Therefore, the player may play the guitar in accordance with the display of the string press mark 13 and/or the tablature symbol 14 on the fingerboard 5.

It is noted that the tablature symbols corresponding to the basic playing method are not designated in the embodiment, so that only the string press mark 13 is displayed on the fingerboard 5 in the basic playing method.

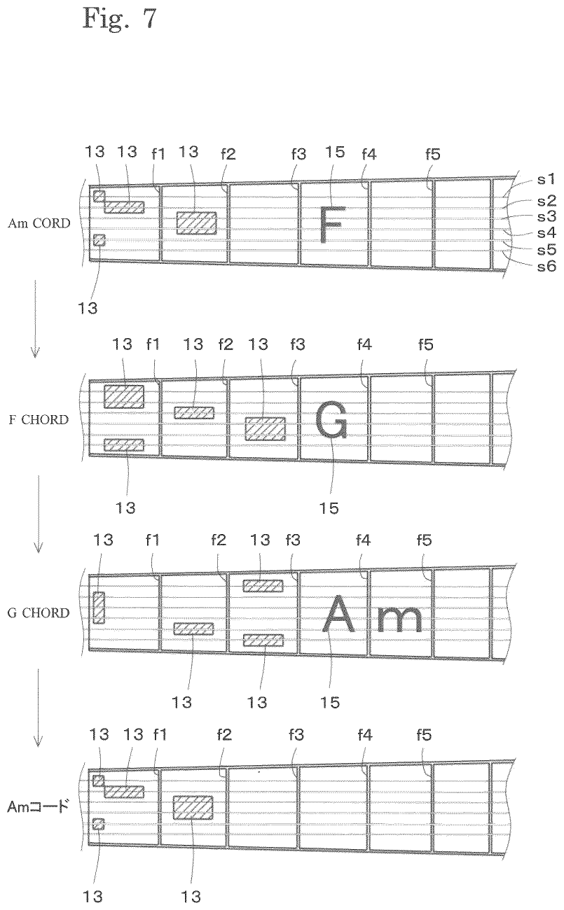

In the case of chord performance, a plurality of strings is required to be pressed at the same time, so that a plurality of string press marks 13 is simultaneously displaced on the fingerboard 5 as illustrated in FIG. 7.

Further, a chord name 15 indicating a chord to be played subsequently may be displayed in proximity to the string press marks 13 thus displayed.

FIG. 7 illustrates an example of display for the musical performance made in the order of “Am chord”, “F chord”, “G chord” and then “Am chord”.

In this manner, displaying the subsequent chord name 15 on the fingerboard 5 enables smoother musical performance of the player, and additionally the player can easily learn the correlation between the chord names 15 and the string pressing positions.

Further, in the first embodiment, the fret member F is secured to the neck body 4 with the coupling members 6 and is out of direct contact with the fingerboard 5 because of the presence of the clearance 7. Thus, the fingerboard 5 is unaffected via the fret(s) 7 by the pressure generated by pressing the string(s).

Therefore, the LCD essentially making up the fingerboard 5 is able to be prevented from suffering damage by the press force.

In the first embodiment, the fret member F is mounted with the clearance 7 kept between the frets f and the fingerboard 5 as illustrated in FIG. 3. However, the clearance 7 is not an absolute necessity. Even if the frets f are in contact with the fingerboard 5, as long as the support portions fa are secured directly or via the coupler portions to the neck body 4 and the frets f span the fingerboard 5, the press force acting on the frets f is transferred from the support portions fa to the neck body 4, thereby mitigating the damage to the fingerboard 5.

The use of the fret member F into which all the frets f are combined by the coupling members 6 facilitates attachment and/or replacement of the frets without the need of alignment of each individual fret f.

As described above, the individual frets f may be attached separately to the neck body 4. In this case, again, the support portions fa at both ends are required to be secured to the neck body 4 to allow the frets f to span the fingerboard 5 so that the fingerboard 5 is not easily acted upon by a press force.

Each individual fret f may be formed, for example, to curve toward the strings s1 to s6 in an arc, rather than formed in a linear manner.

### Second Embodiment

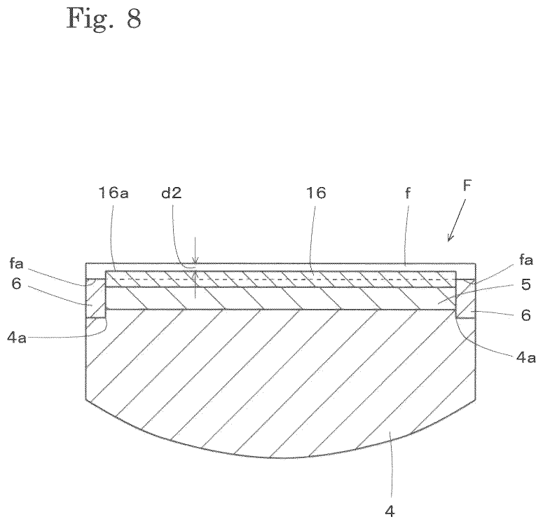

FIG. 8 is a sectional view of a neck 2 according to a second embodiment.

In the second embodiment, a transparent cover member 16 is fitted in to cover the fingerboard 5 between adjacent frets f, f. Other configurations are the same as those in the first embodiment. Similar components to those in the first embodiment are indicated by using the same reference signs as described above, and an individual detailed description is omitted.

The cover member 16 is a transparent plate-shaped member, such as acrylic resin and/or the like, which unblocks the display of the fingerboard 5.

The cover member 16 is designed to maintain a dimensional relationship that prevents the surface 16a of the cover member 16 from extending above the surface of the frets f when the cover member 16 is fitted between frets f, f. Stated another way, the thickness of the cover member 16 is designed to be smaller than a distance d1 from the surface of the fret f to the surface of the fingerboard 5.

In the second embodiment with the cover member 16 fitted in as described above, a distance d2 between the surface of the fret f and the surface 16a of the cover member 16 is smaller than the distance d1 from the surface of the fret f to the surface of the fingerboard 5 according to the first embodiment illustrated in FIG. 3 without the cover member 16 fitted in.

### Operation, Advantageous Effects, Etc.

In the second embodiment, because of the mounting of the cover member 16, the depth of a depression created between adjacent frets f, f arranged to span the fingerboard 5 is reduced by the thickness of the cover member 16 as compared with the first embodiment. The depression portion is an area corresponding to the position in which the player presses the string(s) against the fingerboard 5.

On the other hand, when the strings s1 to s6 are pressed against the fingerboard 5, although the player doesn't always press the strings until the strings come into contact with the fingerboard 5 or the cover member 16, if the depth from the surface of the fret f to the bottom of the depression is too great, the player tends to press the strings too hard. If the player presses the strings harder than necessary, it will put a strain on the player's fingers.

However, in the second embodiment, the depth of the depression between a fret f and a fret f is able to be adjusted by the cover member 16. By adjusting the depth of the depression between frets f, f, when the strings s1 to s6 are pressed against the surface of the cover member 16, the overpress may be prevented.

The embodiments in which the fingerboard 5 essentially made up of the liquid crystal display (LCD) has been described above. However, the liquid crystal display may be replaced with an electroluminescent display. In this case, various marks/symbols can be displayed on the fingerboard 5 without damage to the electroluminescent display by the press of strings.

Further, the marks/symbols to be displayed on the fingerboard 5 are not limited to those in the above embodiments, and any mark/symbol may be displayed.

The above configuration may be applied not only to guitars but to another stringed instrument with frets. This may be applied to, for example, an ukulele, a mandolin, a fretted violin and the like.

### INDUSTRIAL APPLICABILITY

Assistance to improvement of beginner guitar players is able to be provided.

1. A stringed instrument, comprising:
a fingerboard that is mounted on a surface of a neck body and is essentially made up of either a liquid crystal display or an electroluminescent display; and
a plurality of frets that are spaced at predetermined intervals from each other on the fingerboard,
wherein
the frets include support portions at both longitudinal ends, and
the frets are configured to span the fingerboard by securing the support portions to the neck body.

2. The stringed instrument according to claim 1, wherein
the frets are out of contact with the fingerboard.

3. The stringed instrument according to claim 1, further comprising linear coupler portions that are secured to the neck body to couple together the support portions of adjacent frets of the plurality of frets arranged on the fingerboard, wherein all the plurality of frets is combined together.

4. The stringed instrument according to claim 1, further comprising a transparent cover member that covers an area between the adjacent frets on the fingerboard, and maintains a dimensional relationship that prevents a surface of the cover member from extending above surfaces of the frets.

5. The stringed instrument according to claim 1, further comprising:
a receiving portion that receives, from an external terminal, control data synchronized with output of the external terminal; and
a processing portion that controls display on the fingerboard based on the control data received at the receiving portion.

6. The stringed instrument according to claim 5, wherein
the control data output from the external terminal is data for displaying a string press position mark on the fingerboard and in an area corresponding to a position where a string is to be pressed.

7. The stringed instrument according to claim 6, wherein
the control data output from the external terminal is data for displaying a tablature symbol predetermined according to a playing method on the fingerboard and in proximity to the string press position mark displayed.

8. The stringed instrument according to claim 6, wherein
the control data output from the external terminal is data for displaying a chord name to be played next on the fingerboard and in proximity to the string press position mark displayed.

9. The stringed instrument according to claim 2, further comprising linear coupler portions that are secured to the neck body to couple together the support portions of adjacent frets of the plurality of frets arranged on the fingerboard, wherein all the plurality of frets is combined together.
